(19) United States
(12) Patent Application Publication
(10) Pub. No.: US 2003/0187793 A1
(43) Pub. Date: Oct. 2, 2003

(54) Billing system, billing method and billing apparatus

(76) Inventor: Kentaro Sawada, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/336,522

(22) Filed: Jan. 3, 2003

(30) Foreign Application Priority Data
Apr. 1, 2002 (JP) 2002-098793

(51) Int. Cl. G06F 17/60

(52) U.S. Cl. 705/40

(57) ABSTRACT

A billing apparatus, method and system which bill users billing amounts according to settings determined on a user-by-user basis and in compliance with user's wishes. In response to a user's request, a communications relay station relays a communication to a terminal designated destination, and notifies a billing apparatus of the start of service utilization. In the billing apparatus, station data as predetermined billing data and subscriber data as billing data specific to each subscriber are stored in a data section. The billing apparatus presents respective probabilities that billing rates will be determined, which are included in the billing data, to the terminal in advance, urges the user to make a selection, executes a lottery, determines a billing rate, and stores the determined billing rate in the data section, calculates a billing amount based on the billing rate, and notifies the terminal of the billing amount.

### BACKGROUND OF THE INVENTION

(1) Field of the Invention

This invention relates to a billing apparatus, a billing method, and a billing system for billing for a provided service, and more particularly to a billing apparatus, a billing method, and a billing system which are capable of determining a billing amount by lottery.

(2) Description of the Related Art

Recently, the development of communication infrastructures, such as telephone and cellular phone systems, the Internet, and bidirectional television systems, has made it possible to provide various kinds of services through utilization of telecommunications. Further, service providers have been in competition in providing services by differentiating their services from others.

Under these circumstances, it is necessary for each service provider to set a billing rate of a service to a user in a manner differentiated from other services, i.e. to bill the user with differentiations.

For this reason, there are various billing methods employed by systems in which service providers provide their services for users, and bill the users for the provided services. The billing methods include a method of billing according to the count of services provided to a user, a method of billing at a rate determined according to a time period over which a service is provided, and so forth.

In the above methods, however, each billing amount and each rate per unit time are fixedly preset under conditions of a contract made between a service provider and a service user. Another type of conventional billing method is one proposed e.g. by Japanese Laid-Open Patent Publication (Kokai) No. 5-207196, in which special billing amounts and rates are different between days of the week or time zones. However, also in this method, the billing amounts are fixedly preset under conditions of a contract.

In other words, a service user can calculate a billing amount to be paid for a service before being offered if the details of the service or utilization time to be offered can be expected, and all service users under identical conditions are billed the same billing amount. As a result, when it is possible to receive the same kinds of services of the same quality from a plurality of service providers, a service user simply selects a service provider billing least, for actual use. Therefore, each service provider has had no choice but to set a low billing rate for differentiation from their competitors so as to win more service users.

### SUMMARY OF THE INVENTION

The present invention has been made in view of these circumstances, and an object thereof is to provide a billing apparatus, a billing method, and a billing system which are capable of billing users billing amounts according to settings determined on a user-by-user basis and in compliance with user's wishes.

To attain the above object, the present invention provides a billing system in which a service provider bills for a provided service. This billing system comprises a service-using terminal operated by a user of the service for requesting and receiving the service, a communications relay station for providing the service-using terminal with the service in response to a request signal from the service-using terminal, and sending a notification that utilization of the service has started, and a billing apparatus for storing in advance station data as billing data including at least one or more billing information items in which billing rates each defining a billing amount per unit time of utilization of the service are registered, respectively, and subscriber data as billing data specific to each subscriber, receiving the notification, presenting respective probabilities that the billing rates will be determined to the service-using terminal in advance, urging the user to make a selection and executing a lottery, determining a billing rate and storing the billing rate, calculating a billing amount based on the determined billing rate and saving the calculated billing amount, and notifying the service-using terminal of the calculated billing amount.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagram useful in explaining operating principles of a billing system according to the present invention;

FIG. 2 is a functional block diagram of a billing processing section of a billing apparatus according to the embodiment;

FIG. 3 is a diagram showing an example of hardware configuration of the billing apparatus according to the embodiment;

FIG. 4 is a diagram showing the structural relationship among data items of station data in a data section within the billing apparatus;

FIG. 5 is a diagram showing the structural relationship among data items of subscriber data in the data section;

FIG. 6 is a flowchart of a process for basic operations of the billing apparatus;

FIG. 7 is a flowchart of a lottery probability information-determining process included in the FIG. 6 process for the basic operations;

FIG. 8 is a flowchart of a billing information-determining process included in the FIG. 6 process for the basic operations;

FIG. 9 is a flowchart of a billing amount-determining process included in the FIG. 6 process for the basic operations;

FIG. 10 is a flowchart of a lottery execution process which is executed in the FIG. 7 lottery probability information-determining process and the FIG. 8 billing information-determining process;

FIG. 11 is a diagram showing a selection screen for selecting whether or not to use a probability lottery-type variable billing method of the invention;

FIG. 12 is a diagram showing a selection screen for selection of a lottery pattern;

FIG. 13 is a diagram showing another selection screen for selection of a lottery pattern;

FIG. 14 is a diagram showing a notification screen notifying a determined billing amount;

FIG. 15 is a diagram showing a notification screen notifying a determined billing rate which will be applied over a predetermined time period;

FIG. 16 is a diagram showing a selection screen for selecting whether or not to use the probability lottery-type variable billing method of the invention;

FIG. 17 is a diagram showing a selection screen with information of lottery probabilities;

FIG. 18 is a diagram showing a notification screen notifying a determined fee;

FIG. 19 is a diagram showing a selection screen for selection of a lottery pattern; and

FIG. 20 is a diagram showing a warning screen warning a user of shortage of a balance on the user's account.

### DESCRIPTION OF THE PREFERRED EMBODIMENTS

The invention will now be described in detail with reference to drawings showing preferred embodiments thereof.

The operating principles of the present invention will be described here based on a case where the invention is applied to a general telephone exchange system. It should be noted that the case where the invention is applied to the general telephone exchange system will be described as a first embodiment in a section [Telephone Exchange System]. Normally, in a telephone exchange system, at a time point a caller terminates a call, i.e. at termination of a service, a billing process is started, whereupon an actual billing amount is calculated. Therefore, in general, a probability lottery operation (i.e. an operation of presenting probabilities corresponding to billing amounts or rates to a user in advance, allowing the user to make a selection, and executing a lottery) is carried out at this timing. However, the probability lottery operation according to the present invention can be carried out at any time, and hence in the section [Telephone Exchange System], a case of the probability lottery operation being carried out during a service will be described for purposes of generalization. Next, billing processing by an automated teller machine of a bank, which is taken as an example of a case where a billing amount for utilization of the service is determined not based on a service utilization time period, but based on a rate per one time of use, will be described as a second embodiment in a section [Automated Teller Machine]. Further, an example of a case where a service utilization time period alone is recorded at each service-terminating time point, and actual calculation of a billing amount is performed afterward together with calculation of other billing amounts to be paid for services provided within a predetermined time period will be described as a third embodiment in a section [Internet Provider]. Finally, an example of packet billing executed based on the amount of packet data having flowed during utilization of a service will be described as a fourth embodiment in a section [Packet Billing].

[Telephone Exchange System: First Embodiment]

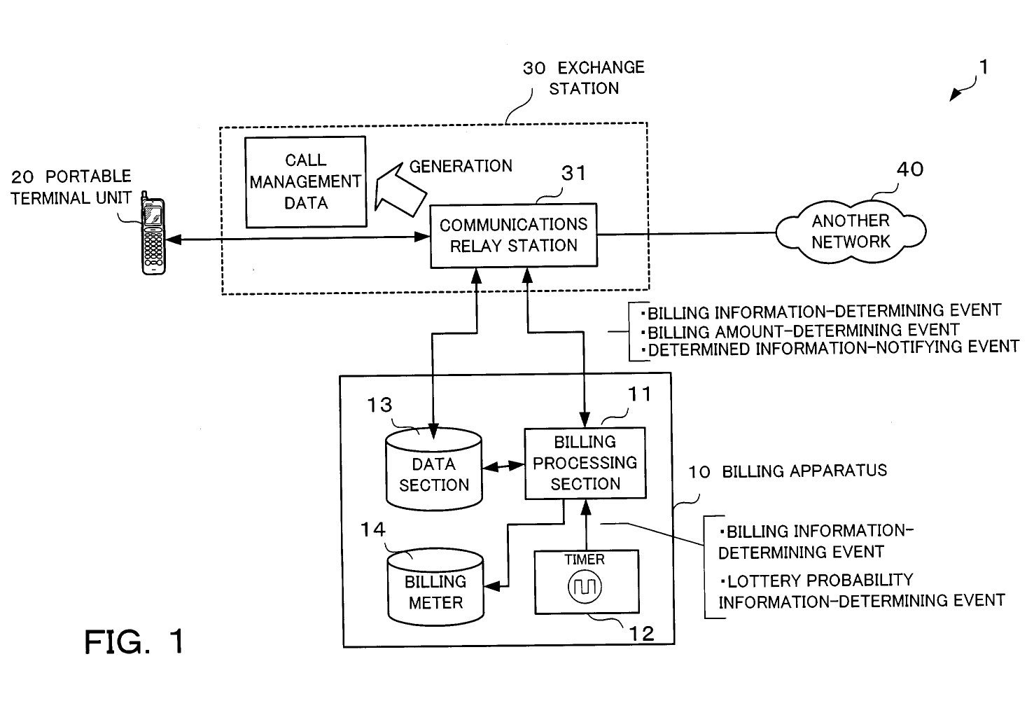

FIG. 1 is a block diagram useful in explaining the operating principles of a billing system according to the present invention. As described hereinabove, the FIG. 1 billing system is described as the first embodiment by taking a telephone exchange system as an example.

The billing system (telephone exchange system) 1 is comprised of a billing apparatus 10 which executes billing processing, a portable terminal unit (hereinafter simply referred to as “the terminal”) 20 via which a subscriber carries out telephone conversation, an exchange station 30 which covers a communication area of the terminal 20, and another network 40 for access to other terminals. The billing apparatus 10 includes a billing processing section 11 for calculating an amount due and the like, a timer 12 for starting a predetermined process periodically, a data section 13 storing in advance station data as predetermined billing data and subscriber data as billing data specific to each subscriber, and a billing meter 14 for storing or saving a finally determined billing amount. Further, the exchange station 30 includes a communications relay station 31 which relays a communication (referred to as “a call” in the first embodiment) from the terminal 20 to another network 40.

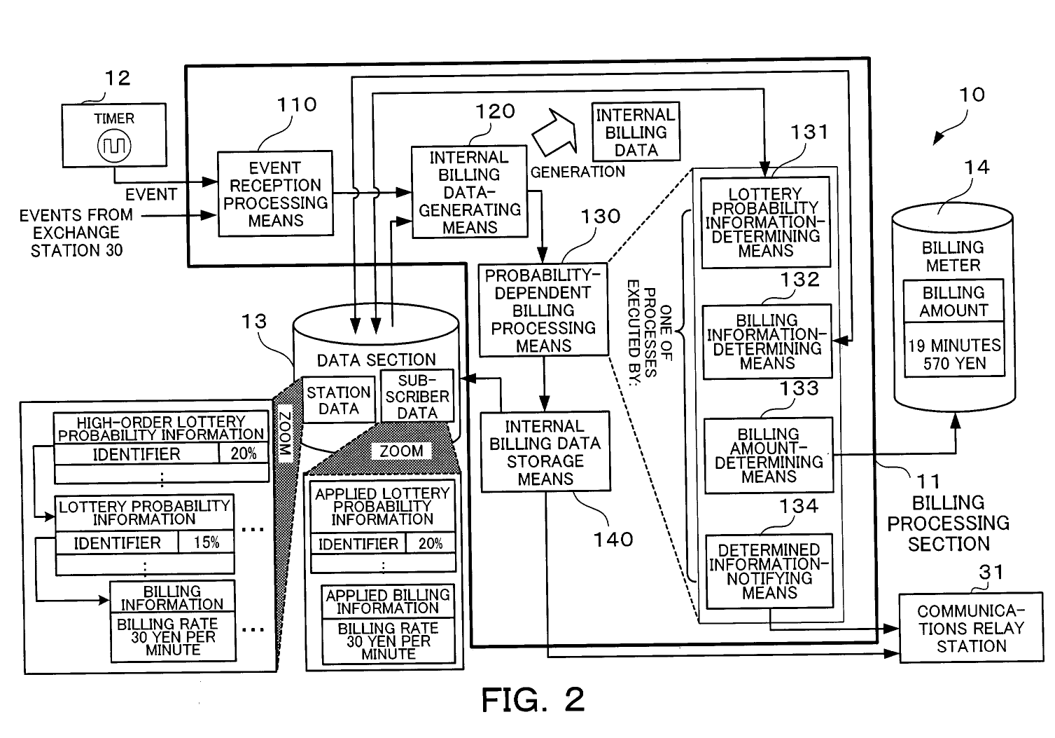

The billing processing section 11 is connected to the communications relay station 31, the timer 12, the data section 13, and the billing meter 14. The billing processing section 11 receives various kinds of events, and presents respective probabilities that billing rates, referred to hereinafter, will be determined or selected, to the terminal 20 in advance. Then, the billing processing section 11 urges the user to make a selection as to presented options, determines a billing rate by lottery, and stores the same. Further, the billing processing section 11 calculates a billing amount based on the billing rate, and stores the calculated billing amount, followed by notifying the terminal 20 of the billing rate and the billing amount. Details of the billing processing section 11 will be described hereinafter with reference to FIG. 2.

The timer 12, which is connected to the billing processing section 11, starts the predetermined process periodically and transmits (notifies) events to the billing processing section 11. In the present embodiment, at a designated time, the timer 12 notifies a billing information-determining event or a lottery probability-determining event to the billing processing section 11.

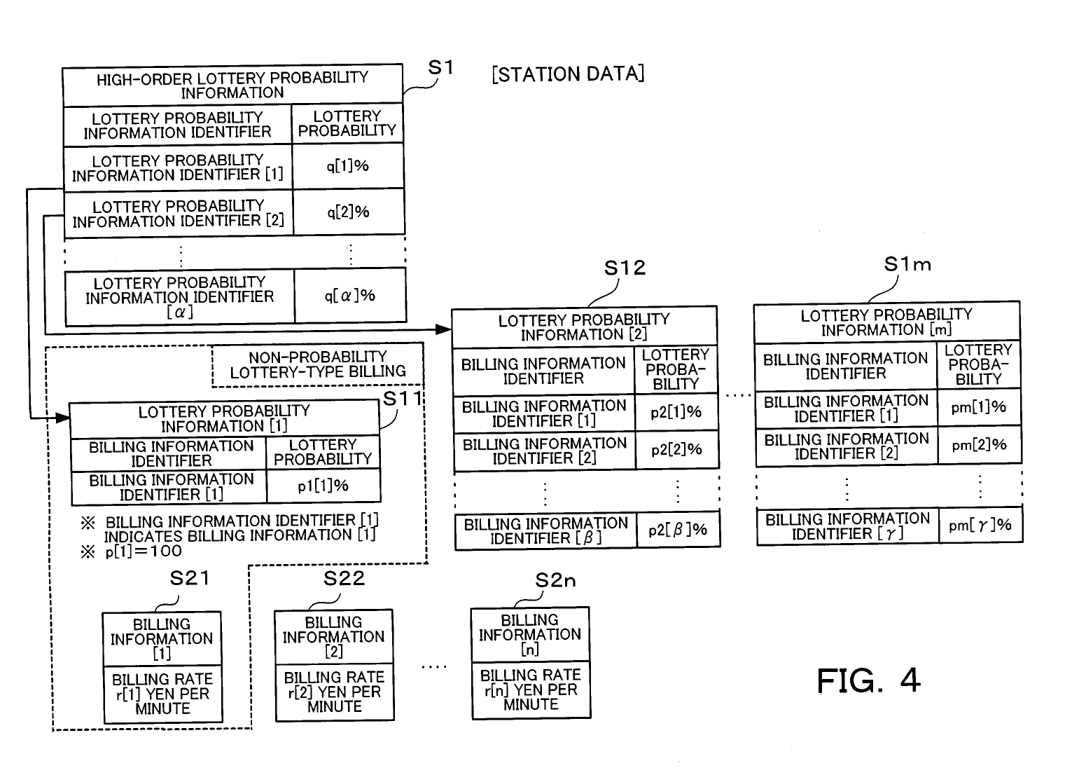

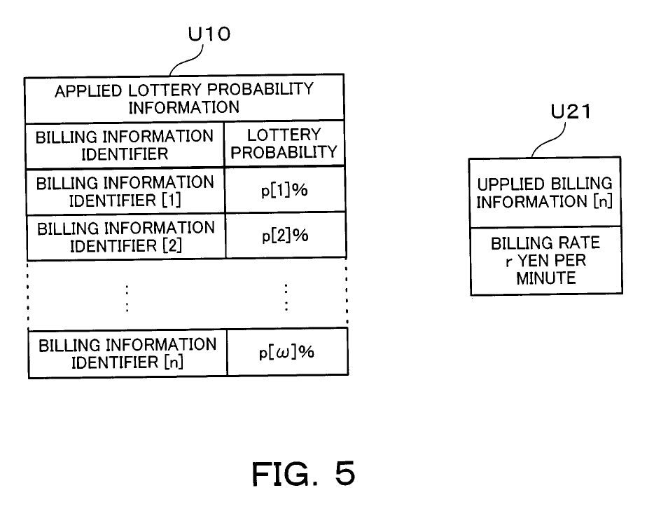

The data section 13 is connected to the communications relay station 31 and the billing processing section 11, and stores the station data as predetermined billing data and the subscriber data as billing data specific to each subscriber. The subscriber data stored in the data section 13 is copied to telephone call management information (hereinafter simply referred to as “call management data”) during generation of the call management data in the exchange station 30. The station data includes at least one or more billing information items in each of which a billing rate defining a billing amount per unit time of utilization of the service is registered. Further, the call management data is generated and continuously managed to be maintained from a time point the terminal 20 is connected to a line (service, such as a call) to a time point it is disconnected, by the exchange station 30. Other information included in the station data and the subscriber data will be described hereinafter with reference to FIGS. 4 and 5. In the following, data of the station data and the subscriber data is generically simply referred to as “the billing data”.

The billing meter 14 which is connected to the billing processing section 11 stores billing information including finally determined billing amounts. The billing meter 14 stores billing amounts each calculated based on a billing rate specifically determined for each service user by the billing processing section 11.

The terminal 20 is connected to the exchange station 30 via a communication medium. A subscriber makes a call via the terminal 20. It should be noted that the communication medium may be a physical medium, such as a metal cable or an optical fiber as a kind of wire, or alternatively it may be a radio medium. Further, the terminal 20 may be any device, such as a telephone set, a cellular phone, an ATM (automated teller machine) or a personal computer, which is capable of performing bidirectional communication with another device. The terminal 20 is connected to the another network 40 via the exchange station 30 to make a call to (or communicate with) another terminal connected to the another network 40. Needless to say, the terminal 20 can also make a call to (or communicate with) another terminal connected to the exchange station 30 via the same.

The communications relay station 31 is connected to the billing apparatus 10, the terminal 20 and the another network 40 via respective communication media, and relays a call transmitted from the terminal 20 to the another network 40 and generates call management data. A call from the terminal 20 can be relayed not only to the another network 40, but also to another terminal connected to the exchange station 30. The communications relay station 31 may be a telephone exchange (subscriber line exchange), a host computer of an ATM, an access server, or the like. The communications relay station 31 confirms that a call from the terminal 20 has started to be in progress, and then recognizes the call as one to be billed for, followed by generating the call management data. Further, after the lapse of a predetermined time period, the communications relay station 31 notifies a billing information-determining event to the billing processing section 11. Then, when the terminal 20 is disconnected after termination of the call, the communications relay station 31 detects the disconnection and notifies a billing amount-determining event to the billing processing section 11. Alternatively, the communications relay station 31 notifies a determined information-notifying event after the lapse of a predetermined time period or in response to the service user's request. It should be noted that generation of the call management data and transmission of various events can be performed by another device which is connected to the communications relay station 31 and controls relay connection for communication. Further, the communications relay station 31 copies billing data (subscriber data) within the data section 13 of the billing apparatus 10 to the call management data during generation thereof.

The another network 40 transfers electric signals (communication signals, data, etc.) within a network formed by communication paths. The another network 40 may be the Internet or a public communication line network.

According to the above arrangement, the service user operates the terminal 20 to request and receive a service. When this request is made, the communications relay station 31 in the exchange station 30 provides a relay connection in response to a request signal from the terminal 20 for communication to a destination designated by the terminal 20. Then, when connection between the terminal 20 and the destination is established by the relay connection, the communications relay station 31 also notifies the billing apparatus 10 (transmits an event notifying) that utilization of the service has started. The billing apparatus 10 has already stored the predetermined station data as billing data including at least one or more billing information items in each of which a billing rate defining a billing amount per unit time of utilization the service is registered and subscriber data as billing data specific to each subscriber, in the data section 13, and when having received the event, the billing apparatus 10 presents respective probabilities that the billing rates will be determined to the terminal 20 beforehand. Then, the user is urged to make a selection as to presented options for execution of a lottery, whereby a billing rate is determined and then stored in the billing meter 14, and a billing amount is calculated based on the billing rate. The calculated billing amount is notified to the terminal 20. Further, the predetermined process is started periodically by the timer 12, and a billing amount, a billing rate, or a lottery probability information item is determined by lottery. Then, a calculated billing amount is stored by the billing meter 14.

Thus, the billing amount can be determined by settings specific to the user in compliance with his wishes.

Next, the functional configuration of the billing processing section 11 within the billing apparatus 10 according to the embodiment will be described in detail with reference to FIG. 2.

FIG. 2 is a functional block diagram of the billing processing section.

As shown in FIG. 2, the billing processing section 11 is comprised of event reception processing means 110 for receiving various events, internal billing data-generating means 120 for generating internal billing data and copying billing data, probability-dependent billing processing means 130 for determining a billing amount and a billing rate by lottery, and internal billing data storage means 140 for storing the internal billing data. Further, the probability-dependent billing processing means 130 executes processing of any of lottery probability information-determining means 131 for determining a lottery probability information item, billing information-determining means 132 for determining a billing information item, billing amount-determining means 133 for determining a billing amount, and determined information-notifying means 134 for notifying the determined billing information item.

The event reception processing means 110 is connected to the timer 12, the communications relay station 31 within the exchange station 30, and the internal billing data-generating means 120, and receives the various events. The event reception processing means 110 receives a billing information-determining event, a billing amount-determining event, or a determined information-notifying event from the exchange station 30. Further, the event reception processing means 110 receives a billing information-determining event or a lottery probability information-determining event sent from the timer 12 after the predetermined process is started. The event reception processing means 110 passes the received events to the internal billing data-generating means 120.

The internal billing data-generating means 120 is connected to the data section 13, the event reception processing means 110, and the probability-dependent billing processing means 130, and generates internal billing data and copies billing data to the same. The internal billing data-generating means 120 generates the internal billing data in a memory within the billing apparatus 10. Further, the internal billing data-generating means 120 identifies a sender of each event delivered via the event reception processing means 110, and when an event is from the exchange station 30, it copies billing data (subscriber data) from the call management data stored in the exchange station 30 to the internal billing data. On the other hand, when an event is from the timer 12, the internal billing data-generating means 120 copies billing data (station data and subscriber data) stored in the data section 13 to the internal billing data. Then, when generation of the internal billing data and copying of the billing data are completed, the internal billing data-generating means 120 passes the event to the probability-dependent billing processing means 130 for transfer of control to the same.

The probability-dependent billing processing means 130 presents the respective probabilities that the billing rates will be determined to the terminal 20 beforehand, based on the event delivered from the internal billing data-generating means 120. Further, the probability-dependent billing processing means 130 urges the user to make a selection as to the presented options, determines a billing rate by lottery, and stores the determined billing rate. Then, the probability-dependent billing processing means 130 calculates a billing amount based on the billing rate, and stores the calculated billing amount, followed by notifying the terminal 20 of the calculated billing amount. More specifically, when an event the probability-dependent billing processing means 130 passed from the internal billing data-generating means 120 is a lottery probability information-determining event, processing is executed by the lottery probability information-determining means 131, and when the event is a billing information-determining event, processing is executed by the billing information-determining means 132. Further, when the event is a billing amount-determining event, processing is executed by the billing amount-determining means 133, while when the event is a determined information-notifying event, processing is executed by the determined information-notifying means 134. Then, after completion of the processing by one of the means 131 to 134, control is transferred to the internal billing data storage means 140. Details of the functions of the respective means 131 to 134 will be described hereafter.

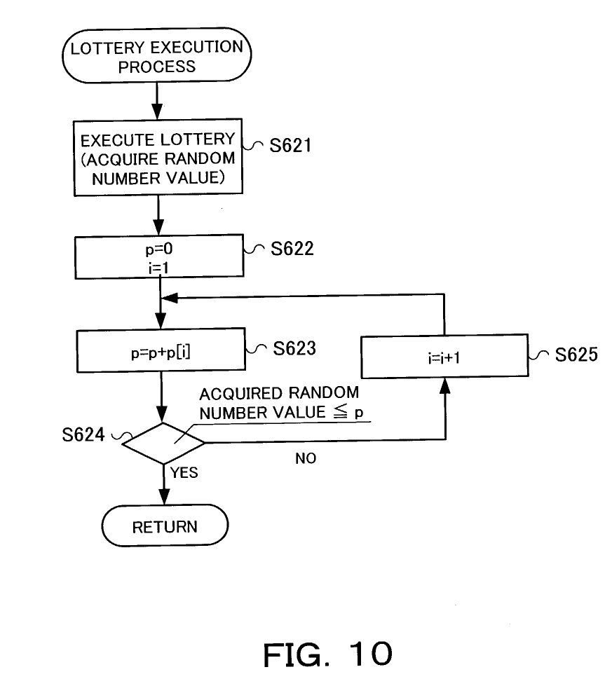

The lottery probability information-determining means 131 is connected to the data section 13, the internal billing data-generating means 120, and the internal billing data storage means 140, and determines a lottery probability information item. When an event passed from the internal billing data-generating means 120 is a lottery probability information-determining event, the lottery probability information-determining means 131 reads out high-order lottery probability information from the internal billing data already stored in the memory of the billing apparatus 10. Further, the lottery probability information-determining means 131 executes a lottery by a lottery execution process, based on the high-order lottery probability information read out, to thereby determine a specific lottery probability information item. It should be noted that the lottery execution process will be described in detail hereinafter with reference to FIG. 10. Further, the lottery probability information-determining means 131 reads out a determined lottery probability information item from the station data stored in the internal billing data. Then, the lottery probability information-determining means 131 copies the lottery probability information item read out (determined) to applied lottery probability information (subscriber data) included in the internal billing data stored in the billing apparatus 10.

The billing information-determining means 132 is connected to the data section 13, the internal billing data-generating means 120, and the internal billing data storage means 140, and determines a billing information item. When an event passed from the internal billing data-generating means 120 is a billing information-determining event, the billing information-determining means 132 determines whether the event was sent from the timer 12 or from the exchange station 30. Further, the billing information-determining means 132 sets an applied billing information determination flag corresponding to the sender, and reads out the applied lottery probability information from the internal billing data only when the applied billing information determination flag is OFF. Further, the billing information-determining means 132 presents probabilities on the applied lottery probability information read out to the terminal 20 beforehand. Then, the billing information-determining means 132 urges the user to make a selection as to the presented options, and executes a lottery by the lottery execution process to thereby select or determine a specific billing information item. The lottery execution process will be described in detail hereinafter with reference to FIG. 10. Further, the billing information-determining means 132 reads out the specific billing information item (station data) indicated by an identifier of the billing information item selected from the internal billing data or the data section 13, and copies the billing information item read out to applied billing information (subscriber data) included in the internal billing data. It should be noted that the copied applied billing information is available from this time on by setting the applied billing information determination flag to the ON state.

The billing amount-determining means 133 is connected to the internal billing data-generating means 120, the internal billing data storage means 140, and the billing meter 14, and determines a billing amount. When an event passed from the internal billing data-generating means 120 is a billing amount-determining event, the billing amount-determining means 133 determines whether the applied billing information determination flag in the internal billing data is ON or OFF. If the flag is OFF, a billing information item to be applied is determined by the billing information-determining means 132, whereas if the flag is ON, the applied billing information is read out from the internal billing data. The applied billing information stores a billing rate recorded in the billing information. The billing amount-determining means 133 calculates an actual billing amount based on the billing rate and a call time measured in advance by connection and disconnection associated with each call, and stores the calculated billing amount in the billing meter 14.

The determined information-notifying means 134 is connected to the internal billing data-generating means 120, the internal billing data storage means 140, and the communications relay station 31, and notifies a billing amount and a billing rate. When an event passed from the internal billing data-generating means 120 is a determined information-notifying event, the determined information-notifying means 134 notifies a billing amount determined by the billing amount-determining means 133 to the exchange station 30 from which the event is sent, or a lottery probability information item used for selection of the billing amount to the terminal 20 via the communications relay station 31.

The internal billing data storage means 140 is connected to the data section 13, the communications relay station 31, and the probability-dependent billing processing means 130, and stores internal billing data. Here, after one of the processes executed by the probability-dependent billing processing means 130 is terminated, the internal billing data storage means 140 stores the determined lottery probability information item or applied billing information, or the applied billing information determination flag in the internal billing data within the billing processing section 11, in the subscriber data in the data section 13, if the received event is from the timer 12, whereas if the received event is from the exchange station 30, the internal billing data storage means 140 stores the determined lottery probability information item or applied billing information, or the applied billing information determination flag in the internal billing data within the billing processing section 11, in the call management data in the exchange station 30.

According to the functional configuration described above, the predetermined station data as billing data including at least one or more billing information items in each of which a billing rate defining a billing amount per unit time of utilization the service is registered and subscriber data as billing data specific to each subscriber are stored in the data section 13 in advance.

First, the communications relay station 31 notifies an event (a billing information-determining event, a billing amount-determining event or a determined information-notifying event) as a predetermined message. Alternatively, the timer 12 starts the predetermined process periodically to thereby notify a timer event (a billing information-determining event or a lottery probability information-determining event) as a predetermined message.

Then, in the billing processing section 11, the event reception processing means 110 receives an event notified by the communications relay station 31 after the station 31 has confirmed that connection to a service has been established. Alternatively, the event reception processing means 110 receives a timer event sent from the timer 12 after the start of the predetermined process. After reception of the event, the internal billing data-generating means 120 generates station data or subscriber data as billing data, as internal billing data in the memory within the apparatus. When the internal billing data is generated, the probability-dependent billing processing means 130 presents the respective probabilities that the billing rates will be determined, to the terminal 20 beforehand. Further, the probability-dependent billing processing means 130 urges the user to make a selection as to the presented options, determines a billing rate by lottery, and stores the determined billing rate. Then, the probability-dependent billing processing means 130 calculates a billing amount based on the billing rate, and stores the calculated billing amount, followed by notifying the terminal 20 of the calculated billing amount. When the probability-dependent billing process is terminated, the internal billing data storage means 140 stores the internal billing data in the data section 13 or in the communications relay station 31.

Then, the billing amount calculated by the billing processing section 11 is stored in the billing meter 14.

Thus, a user-specific the billing amount can be determined according settings specific to the user in compliance with user's whishes.

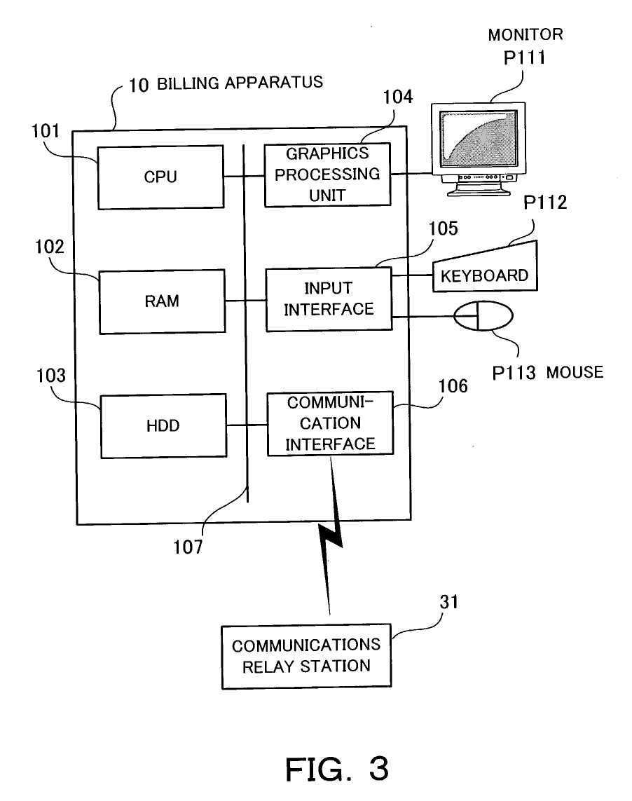

FIG. 3 shows an example of the hardware configuration of the billing apparatus according to the embodiment of the invention. The overall operation of the billing apparatus 10 is controlled by a CPU (Central Processing Unit) 101. Connected via a bus 107 to the CPU 101 are a RAM (Random Access Memory) 102, an HDD (Hard Disk Drive) 103, an graphics processing unit 104, an input interface 105, and a communication interface 106.

The RAM 102 temporarily stores at least part of the programs of an OS (Operating System) and application programs, executed by the CPU 101. The RAM 102 further stores various kinds of data (such as the internal billing data in the billing apparatus 10 of the embodiment) necessary for processing by the CPU 101. The HDD 103 stores the OS and application programs.

The graphics processing unit 104 is connected to a monitor P111. The graphics processing unit 104 causes an image to be displayed on a screen of the monitor P111 in accordance with an instruction from the CPU 101. The input interface 105 has a keyboard P112 and a mouse P113 connected thereto and transmits a signal delivered from the keyboard P112 or the mouse P113 to the CPU 101 via the bus 107.

The communication interface 106 is connected to the communications relay station 31. The communications relay station 31 may be a telephone exchange (subscriber line exchange), a host computer of an ATM, an access server, or the like. The communication interface 106 exchanges data with another computer (terminal) via the communications relay station 31.

The processing functions of the present embodiment applied to the billing apparatus 10 can be realized by the above configuration of the hardware. For instance, when the power of the FIG. 3 communications relay station 31 is turned ON, part of the programs of the OS stored in the HDD 103 is read into the RAM 102, and the programs of the OS are executed by the CPU 101, whereby the operation of the OS is started on the CPU 101. Based on the OS, the programs realizing the functions of the present embodiment are executed and managed.

Next, a description will be given of the data structure of the data section 13 of the billing apparatus 10 of the billing system.

FIG. 4 shows the structural relationship between data items of the station data in the data section within the billing apparatus 10.

As shown in FIG. 4, the station data of the present embodiment includes high-order lottery probability information S1, lottery probability information items S11 to S1m, and billing information items S21 to S2n.

The high-order lottery probability information S1 associates a plurality of lottery probability information identifiers for identifying the respective lottery probability information items S11 to S1m with a plurality of lottery probabilities as probabilities determined by the identified lottery probability information items, respectively, for management. It should be noted that the lottery probabilities can be arbitrarily changed.

Each of the lottery probability information items S11 to S1m manages a plurality of billing information identifiers for identifying the respective billing information items S21 to S2n with a plurality of lottery probabilities as probabilities determined by the identified billing information items, respectively, for management. It should be noted that in each of the lottery probability information items S11 to S1m, lottery probabilities are set such that the total sum thereof are equal to 100, and the relative proportion of the lottery probabilities can be arbitrarily changed. Further, where a lottery probability information item has a billing information identifier corresponding to a lottery probability of 100%, no probability lottery is performed. In FIG. 4, this billing method is shown as non-probability lottery-type billing. This case corresponds to the lottery probability information item S11, wherein the billing information identifier indicates the billing information item S21.

The billing information items S21 to S2n each store a billing rate indicative of a charge per unit time. Further, one or more of the billing information items are associated with each of the lottery probability information items S11 to S1m. It should be noted that the billing information items can be arbitrarily increased or decreased in number, or changed.

FIG. 5 shows the structural relationship among data items of the subscriber data in the data section within the billing apparatus 10.

As shown in FIG. 5, the subscriber data of the present embodiment is comprised of applied lottery probability information U10 and applied billing information U21. It should be noted that the subscriber data includes the applied billing information determination flag, not shown, indicative of whether the applied billing information has been determined.

The applied lottery probability information U10 associates the billing information identifiers appearing in FIG. 4, for identifying the respective billing information items S21 to S2n of the station data, with the lottery probabilities as probabilities determined by the identified billing information items, for management. The lottery probabilities are determined by the lottery probability information-determining means 131.

The applied billing information U21 stores a billing rate indicative of a charge per unit time. The billing rate is determined by the billing information-determining means 132.

Next, the basic operations of the system according to the first embodiment will be described in detail with reference to FIGS. 1 to 10.

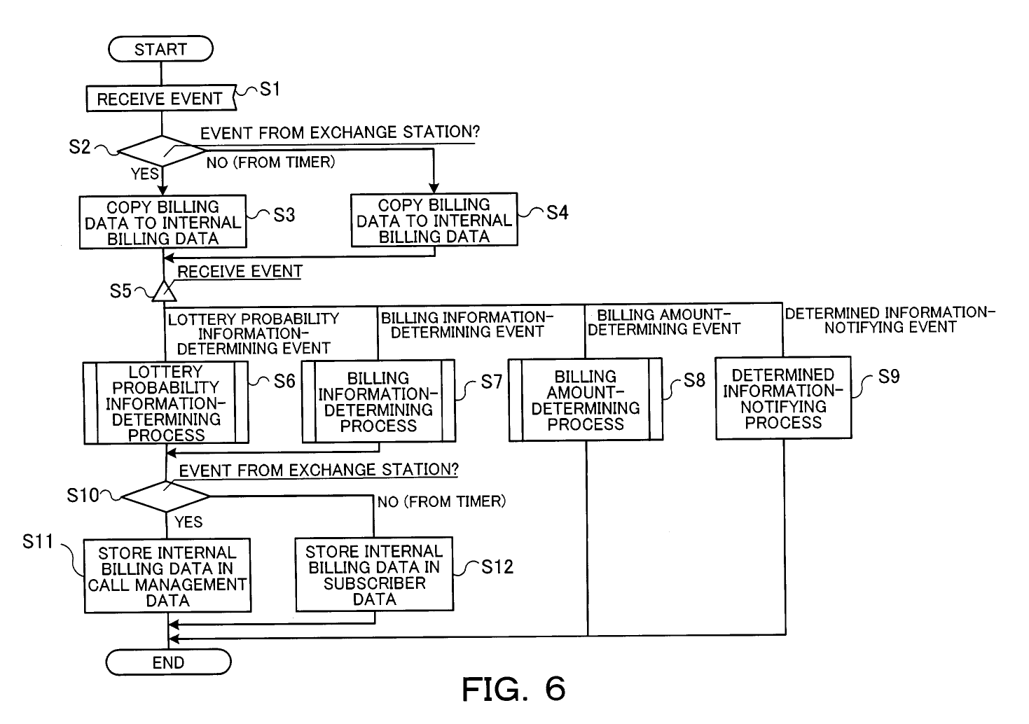

FIG. 6 is a flowchart showing a process for the basic operations of the billing apparatus of the present embodiment. This process is started when the billing apparatus 10 has received an event from the exchange station 30 or the timer 12, and executed by the CPU 101. In the following, the FIG. 6 process will be described in the order of step numbers. It should be noted that the names of respective functions in the present flowchart are identical to those of the corresponding functions in FIGS. 1 and 2.

[Step S1] First, the exchange station 30 confirms that a call from the terminal 20 has started to be in progress, and then recognizes the call as one to be billed for. After the lapse of a predetermined time period, the exchange station 30 notifies a billing information-determining event to the billing processing section 11. In this case, the event reception processing means 110 in the billing processing section 11 receives the notified billing information-determining event.

When the terminal 20 terminates the call and is disconnected, the exchange station 30 detects the disconnection and notifies a billing amount-determining event to the billing processing section 11 or a determined information-notifying event. In this case, the event reception processing means 110 in the billing processing section 11 receives the notified billing amount-determining event or determined information-notifying event.

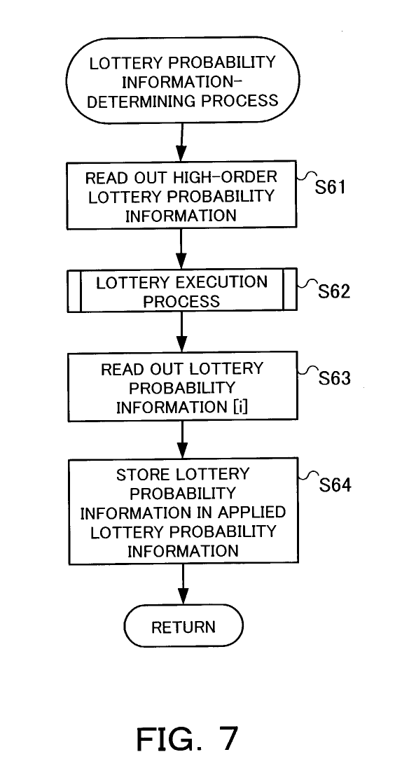

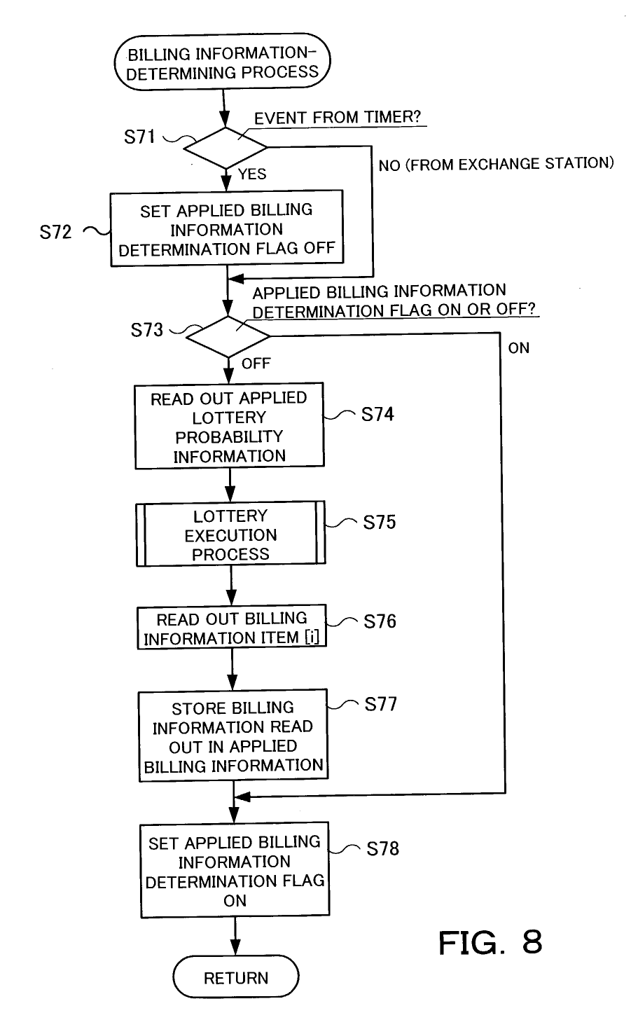

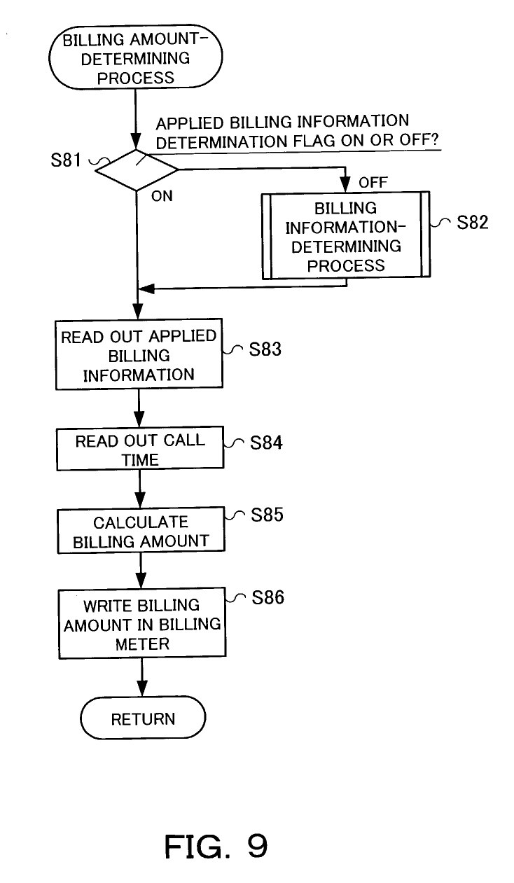

Further, when it becomes a time designated in advance, the timer 12 of the billing apparatus 10 detects this condition and notifies a billing information-determining event or a lottery probability-determining event to the billing processing section 11. In this case, the event reception processing means 110 in the billing processing section 11 receives the notified billing information-determining event or lottery probability-determining event.

[Step S2] The internal billing data-generating means 120 in the billing processing section 11 determines whether the received event was delivered from the exchange station 30 or the timer 12. If the event was delivered from the exchange station 30, the program proceeds to a step S3, whereas if the event was delivered from the timer 12, the program proceeds to a step S4.

[Step S3] Since it was determined in the step S2 that the event was delivered from the exchange station 30, the internal billing data-generating means 120 copies billing data on the call management data to internal billing data. It should be noted that the call management data is generated and continuously managed to be maintained from a time point the terminal 20 is connected to a line (service, such as a call) to a time point it is disconnected, by the exchange station 30. During generation of the call management data, subscriber data stored in the data section 13 is copied to the call management data in the exchange station 30.

[Step S4] Since it was determined in the step S2 that the event was delivered from the timer 12, the internal billing data-generating means 120 copies billing data (station data and subscriber data) in the data section 13 to the internal billing data.

[Step S5] The probability-dependent billing processing means 130 in the billing processing section 11 determines the kind of the event received in the step S1. Then, if the received event is the lottery probability information-determining event, the program proceeds to a step S6, or if the event is the billing information-determining event, the program proceeds to a step S7. Further, if the event is the billing amount-determining event, the program proceeds to a step S8, or if the event is the determined information-notifying event, the program proceeds to a step S9.

[Step S6] Since it was determined in the step S5 that the received event is the lottery probability information-determining event, the lottery probability information-determining means 131 in the billing processing section 11 recognizes the event as the lottery probability information-determining event, and executes a lottery probability information-determining process. It should be noted that the lottery probability information-determining process will be described in detail hereinafter with reference to FIG. 7.

[Step S7] Since it was determined in the step S5 that the received event is the billing information-determining event, the billing information-determining means 132 in the billing processing section 11 recognizes the event as the billing information-determining event, and executes a billing information-determining process. It should be noted that the billing information-determining process will be described in detail hereinafter with reference to FIG. 8.

[Step S8] Since it was determined in the step S5 that the received event is the billing amount-determining event, the billing amount-determining means 133 in the billing processing section 11 recognizes the event as the billing amount-determining event, and executes a billing amount-determining process. It should be noted that the billing amount-determining process will be described in detail hereinafter with reference to FIG. 9.

[Step S9] Since it was determined in the step S5 that the received event is the determined information-notifying event, the determined information-notifying means 134 in the billing processing section 11 recognizes the event as the determined information-notifying event, and executes a determined information notifying process. In the determined information notifying process, a determined billing information item, a billing amount calculated based thereon, or a lottery probability information item used to select the billing information item is notified to the service user. [Step S10] The internal billing data storage means 140 determines whether the received event was delivered from the exchange station 30 or the timer 12. If the event was delivered from the exchange station 30, the program proceeds to a step S11, whereas if the event was delivered from the timer 12, the program proceeds to a step S12.

[Step S11] Since it was determined in the step S10 that the event was delivered from the exchange station 30, the internal billing data storage means 140 copies the determined applied lottery probability information or applied billing information, or the applied billing information determination flag, existing in the internal billing data, to the call management data within the exchange station 30, followed by terminating the whole process executed in response to the event.

[Step S12] Since it was determined in the step S10 that the event was delivered from the timer 12, the internal billing data storage means 140 stores the determined applied lottery probability information or applied billing information determined by the lottery probability information-determining process or the billing information-determining process, or the applied billing information determination flag, existing in the internal billing data, in the subscriber data in the data section 13, followed by terminating the whole process executed in response to the event.

FIG. 7 is a flowchart of the lottery probability information-determining process in the FIG. 6 process for the basic operations of the billing apparatus 10. The step S6 (the lottery probability information-determining process) in FIG. 6 is carried out following a procedure described below. The lottery probability information-determining process is executed by the lottery probability information-determining means 131 in the billing processing section 11 when an event is delivered from the timer 12.

[Step S61] The high-order lottery probability information is read out from the internal billing data stored in the memory within the billing apparatus 10.

[Step S62] Based on the high-order lottery probability information read out in the step S61, a lottery is executed by the lottery execution process to determine a specific lottery probability information item. It should be noted that what is determined here is a lottery probability information identifier [i] of the high-order lottery probability information. Details of the lottery execution process will be described hereinafter with reference to FIG. 10.

[Step S63] The specific lottery probability information item [i] indicated by the lottery probability information identifier of the high-order lottery probability information determined in the step S62 is read out from the station data stored in the internal billing data. It should be noted that [i] of the lottery probability information item is identical to the [i] of the lottery probability information identifier, which represents an i-th address within a predetermined storage area at which the lottery probability information item is stored.

[Step S64] The lottery probability information read out (determined) in the step S63 is copied to the applied lottery probability information in the internal billing data stored in the billing apparatus 10.

FIG. 8 is a flowchart of the billing information-determining process in the FIG. 6 process for the basic operations of the billing apparatus 10. The step S7 (billing information-determining process) of FIG. 6 is carried out following a procedure described below. The billing information-determining process is executed by the billing information-determining means 132 in the billing processing section 11.

[Step S71] The billing apparatus 10 determines whether the billing information-determining event was sent from the timer 12 or from the exchange station 30. If the billing information-determining event was sent from the timer 12, the program proceeds to a step S72, whereas if the event was sent from the exchange station 30, the process jumps to a step S73.

[Step S72] Since it was determined in the step S71 that the billing information-determining event had been sent from the timer 12, the applied billing information determination flag in the internal billing data stored in the billing apparatus 10 is set OFF.

[Step S73] It is determined whether the applied billing information determination flag is ON or OFF. If the flag is determined here to be OFF, the program proceeds to a step S74, whereas if the flag is determined to be ON, the billing information-determining process is terminated, followed by the program returning to the step S7 of FIG. 6.

[Step S74] Since the applied billing information determination flag was determined to be OFF in the step S73, the applied lottery probability information is read out from the internal billing data.

[Step S75] The billing processing section 11 presents the applied lottery probability information read out in the step S74 to the terminal 20 beforehand, and urges the service user to make a selection. Then, the billing processing section 11 executes a lottery by the lottery execution process to determine a specific billing information item. What is determined here is a billing information identifier [i] of the applied lottery probability information. Details of the lottery execution process will be described hereinafter with reference to FIG. 10.

[Step S76] The specific billing information item [i] indicated by the billing information identifier of the applied lottery probability information determined in the step S75 is read out from the station data stored in the internal billing data or the data section 13. It should be noted that [i] of the billing information item [i] is identical to the [i] of the billing information identifier [i], which represents an i-th address within a predetermined storage area at which the billing information item is stored. In the case of a semiconductor memory or an imaginary memory, this address simply represents an address, while in the case of a disk medium, it represents a recording position information item, such as a track number or a sector number. Further, in the case of a file system, the address represents a specific file.

[Step S77] The billing information item read out in the step S76 is copied to the applied billing information in the internal billing data.

[Step S78] The applied billing information determination flag is set ON for the applied billing information to which the billing information item was copied in the step S77, followed by terminating the billing information-determining process.

FIG. 9 is a flowchart of the billing amount-determining process in the FIG. 6 process for the basic operations of the billing apparatus 10. The step S8 (billing amount-determining process) of FIG. 6 is carried out following a procedure described below. The billing amount-determining process is executed by the billing amount-determining means 133 in the billing processing section 11.

[Step S81] The billing apparatus 10 determines whether the applied billing information determination flag in the internal billing data stored in the billing apparatus 10 is ON or OFF. If the flag is ON in the step, the program proceeds to a step S83, whereas if the flag is OFF, the program proceeds to a step S82.

[Step S82] Since the applied billing information determination flag was determined to be OFF in the step S81, a billing information item to be applied by the billing information-determining process is determined. It should be noted that the billing information-determining process was already described in detail with reference to FIG. 8.

[Step S83] Since the applied billing information determination flag was set ON after execution of the step S81 or the steps S81 and S82, the applied billing information is read out from the internal billing data.

[Step S84] The billing rate registered in the applied billing information and the call time measured in advance by the connection and disconnection for a call are read out.

[Step S85] An actual billing amount is calculated based on the billing rate and the call time read out in the step S84.

[Step S86] The billing amount determined in the step S85 is stored in the billing meter 14, followed by terminating the billing amount-determining process.

FIG. 10 is a flowchart of the lottery execution process in the FIG. 7 lottery probability information-determining process and the FIG. 8 billing information-determining process. The step S62 (lottery execution process) in FIG. 7 or the step S75 (lottery execution process) in FIG. 8 is carried out following a procedure described below. The lottery execution process is executed by the lottery probability information-determining means 131 or the billing information-determining means 132 in the billing processing section 11.

[Step S621] Pseudo-random numbers are generated within a predetermined range, and one (random number value) of the numbers is acquired.

[Step S622] A variable p is cleared to zero (p=0), and the count of a loop counter i is set to 1 (i=1).

[Step S623] A variable p[i] is added to the variable p, and the result of the addition is stored in the variable p (p=p+p[i]).

[Step S624] Comparison is performed between the acquired random number value and the value of the variable p. If the acquired random number value is equal to or smaller than the variable p, the lottery execution process is terminated, whereas if the acquired random number value is larger than the variable p, the program proceeds to a step S625.

[Step S625] Since it was determined in the step S624 that the acquired random number value was larger than the variable p, the loop counter i is incremented by 1 (i=i+1). Then, the program returns to the step S623, and the steps S623 et seq. are repeatedly executed.

Next, the overall operation of the system of the first embodiment is described with reference to FIGS. 1 to 10. In the following, several methods of utilizing the system of the first embodiment are described in detail.

First, a case of a billing amount being determined immediately after utilization of a service will be described as “Utilization Example 1.”

### UTILIZATION EXAMPLE 1

When the terminal 20 originates a call, the communications relay station 31 in the exchange station 30 detects it and generates call management data as management information needed for processing, in the exchange station 30. As described hereinbefore, this call management data is maintained and managed until a service ends by disconnection of the terminal 20. On the other hand, the lottery probability information and the billing information are stored as the station data in the data section 13 of the billing apparatus 10. Further, the data section 13 stores the subscriber data defining data specific to each subscriber. The subscriber data includes not only the applied lottery probability information and the applied billing information, but also the applied billing information determination flag indicative of whether the applied billing information has already been determined. It should be noted that the applied lottery probability information, the applied billing information, and the applied billing information determination flag are generically referred to as the billing data in the present embodiment. Now, in the present utilization example 1, it is assumed that the applied billing information determination flag has been set OFF, and the applied billing information has been cleared to zero.

Then, when the call management data is generated, the exchange station 30 copies the billing data from the subscriber data to the call management data. The exchange station 30 confirms that the call from the terminal 20 has started to be in progress, and then recognizes the call as one to be billed for. After the lapse of a predetermined time period, the exchange station 30 notifies a billing information-determining event to the billing processing section 11 (step S1). On the other hand, the billing processing section 11 determines that the received event was sent from the exchange station 30 (step S2), and copies the billing data in the call management data to the internal billing data in the billing processing section 11 (step S3). Further, the billing processing section 11 determines the kind of the received event (step S5), and when recognizing the event as a billing information-determining event, executes the billing information-determining process (step S7). In the billing information-determining process, it is confirmed that the billing information-determining event was sent from the exchange station 30 (step S71) and that the applied billing information determination flag in the internal billing data is OFF (step S73), and then the applied lottery probability information is read out from the internal billing data (step S74). Thereafter, the billing processing section 11 executes a lottery in accordance with probabilities in the applied lottery probability information read out, and selects one billing information item (step S75). A typical example of the processing is as follows.

Random numbers within a range of 1 to 100 are generated, and one of them is acquired (step S621). The variable p is cleared to zero, and the count of the loop counter i is set to 1 (step S622). In the present example, it is assumed that the acquired random number value is 50, the probability of the first billing information item being selected is 30%, and the probability of the second billing information item being selected is 70%. First, p[1], i.e. 30, is added to p (step S623), and hence p becomes equal to 30. Then, the acquired random number value 50 is compared with the value 30 of p (step S624). Since the condition that an acquired random number value is equal to or smaller than the variable p is not satisfied, the loop counter i is incremented by 1 (step S625). Then, p[2], i.e. 70, is added to p (step S623), and hence p becomes equal to 100. Since the acquired random number value 50 is smaller than the value 100 of the variable p, the comparison condition (step S624) is satisfied, so that the program proceeds to the following step (step S76 in FIG. 8). This means that the second billing information item indicated by the loop counter i has been selected. Thus, if the acquired random number value is within a range of 1 to 30, the first billing information item is selected, while if the acquired random number value is within a range of 31 to 100, the second billing information item is selected. In short, the lottery is executed in accordance with the probabilities.

Then, a specific billing information item identified by the selected billing information identifier is read out (step S76). The billing information item read out is copied to the applied billing information in the internal billing data (step S77), and then the applied billing information determination flag is set ON (step S78), followed by terminating the billing information-determining process. Thereafter, it is determined that the event was from the exchange station 30 (step S10), and the internal billing data is stored in the call management data (step S11), followed by terminating the whole process executed in response to the event.

Then, when the terminal 20 is disconnected after terminating the call, the exchange station 30 detects the disconnection and notifies a billing amount-determining event to the billing processing section 11 (step S1). The billing processing section 11 determines the kind of the received event (step S5), and when recognizing the event as the billing amount-determining event, executes the billing amount-determining process (step S8). In the billing amount-determining process, after it is confirmed that the applied billing information determination flag in the internal billing data is ON (step S81), the applied billing information is read out from the internal billing data (step S83), and a billing rate registered in the applied billing information and a call time are obtained (step S84) to calculate an actual billing amount (step S85). Then, the determined billing amount is stored in the billing meter 14 (step S86), followed by terminating the process.

Thus, billing by probability lottery for the call by the terminal 20 is accomplished.

Next, a case of billing for a service provided over a predetermined time period will be described as “Utilization Example 2.” In this example, it is assumed that the applied billing information determination flag in the subscriber data has been set ON, and data generated when a preceding event occurred remains set in the applied billing information.

### UTILIZATION EXAMPLE 2

First, when it becomes a time designated in advance, the timer 12 detects this condition and notifies a billing information-determining event to the billing processing section 11 (step S1). The billing processing section 11 determines the kind of the received event (step S5), and when recognizing the event as a billing information-determining event, executes the billing information-determining process (step S7). Since the applied billing information determination flag is ON at the start of the billing information-determining process, when it is determined that the event was sent from the timer 12 (step S71), the applied billing information determination flag in the internal billing data is set OFF (step S72) to enable the applied billing information to be updated. When the billing information-determining process is terminated, the determined applied billing information and the applied billing information determination flag are stored in the subscriber data (step S12).

Thereafter, when the terminal 20 originates a call, since a billing information-determining event is from the exchange station 30 (step S71), and the applied billing information determination flag is ON (step S73), the applied billing information is not set anew, but the billing information already set is used.

Next, a case of executing another lottery for determining a distribution pattern of lottery probabilities for use in the above lottery will be described as “Utilization Example 3.”

### UTILIZATION EXAMPLE 3

Now, it is assumed that station data stored in the data section 13 includes not only one or more lottery probability information items and billing information items, but also a high-order lottery probability information item defining each probability that one lottery probability information item will be selected from the one or more lottery probability information items. In this case, subscriber data includes applied lottery probability information defining a lottery probability information item to be used by the subscriber, and this applied lottery probability information is also copied to internal billing data when the internal billing data is generated. When it becomes a time designated in advance, the timer 12 detects this condition and notifies a lottery probability information-determining event to the billing processing section 11 (step S1). The billing processing section 11 determines the kind of the received event (step S5), and when recognizing the event as a lottery probability information-determining event, executes the lottery probability information-determining process (step S6). At the start of the lottery probability information-determining process, the high-order lottery probability information item is read out from the internal billing data (step S61), and then a lottery is carried out to determine a specific lottery probability information item (step S62). After the determined lottery probability information item is read out from the station data (step S63) and copied to the internal data (step S64), it is determined that the event was sent from the timer 12 (step S10), and then the internal data is stored in the subscriber data within the data section 13 (step S12).

Thereafter, when the events described in “Utilization Example 1” and “Utilization Example 2” occurs, the billing processing section 11 executes billing processing by using the applied lottery probability information set before.

Next, a case of carrying out normal billing without executing the lottery will be described as “Utilization Example 4.”

### UTILIZATION EXAMPLE 4

In the case where the probability lottery-type variable billing method of the invention is not employed, lottery probability information which allows billing information contracted beforehand to be selected with 100% probability is set in the applied lottery probability information in the subscriber data.

Next, a case of determining whether or not to select the probability lottery-type variable billing method will be described as “Utilization Example 5.”

### UTILIZATION EXAMPLE 5

A service user orally reports to an operator on the service provider side in advance as to whether he wishes the probability lottery-type variable billing method of the invention. Alternatively, the service user sends numerical information via a telephone terminal or utilizes the Internet, e.g. by the WWW, to select whether to use the probability lottery-type variable billing method of the invention.

Next, a case where a service user is permitted to select a probability information item for use in a lottery will be described as “Utilization Example 6.”

### UTILIZATION EXAMPLE 6

A service user orally reports a lottery probability information item to be applied to a lottery to an operator on the service provider side in advance, or alternatively, sends numerical information via a telephone terminal device or utilizes the Internet, e.g. by the WWW, to select the lottery probability information item. The lottery probability information item selected by the service user is set as applied lottery probability information in subscriber data.

Next, a case where a service user is permitted to select a distribution pattern of lottery probabilities for use in a lottery (i.e. a high-order lottery probability information item) will be described as “Utilization Example 7.”

### UTILIZATION EXAMPLE 7

A service user orally reports a high-order lottery probability information item to be applied to a lottery to an operator on the service provider side in advance, or alternatively, sends numerical information via a telephone terminal device or utilizes the Internet e.g. by the WWW to select the high-order lottery probability information item. The high-order lottery probability information item selected by the service user is set as a high-order lottery probability information item in subscriber data.

Next, a case where a service user is notified of processing results of the billing determination process and so forth will be described as “Utilization Example 8.”

### UTILIZATION EXAMPLE 8

In response to a reply to a determined information-notifying event from the billing apparatus 10 after a call has been cleared, the communications relay station 31 within the exchange station 30 sends a voice notification to the terminal 20, or adds character information of a billing amount or a lottery probability information item used for selecting the billing amount to a call-clearing message included in a control message.

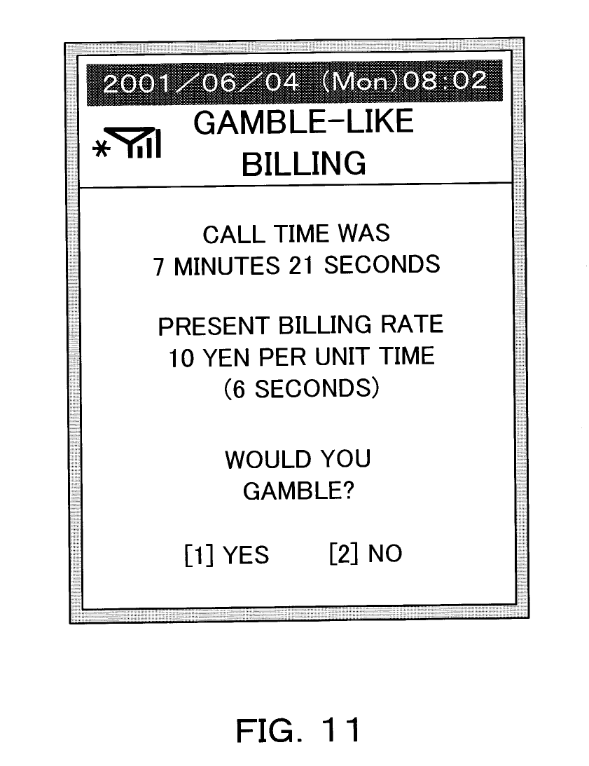

Next, images displayed on a screen of the terminal of a cellular phone as viewed by a user when the billing method of the invention is applied to a portable telephone system are illustrated in FIGS. 11 to 15.

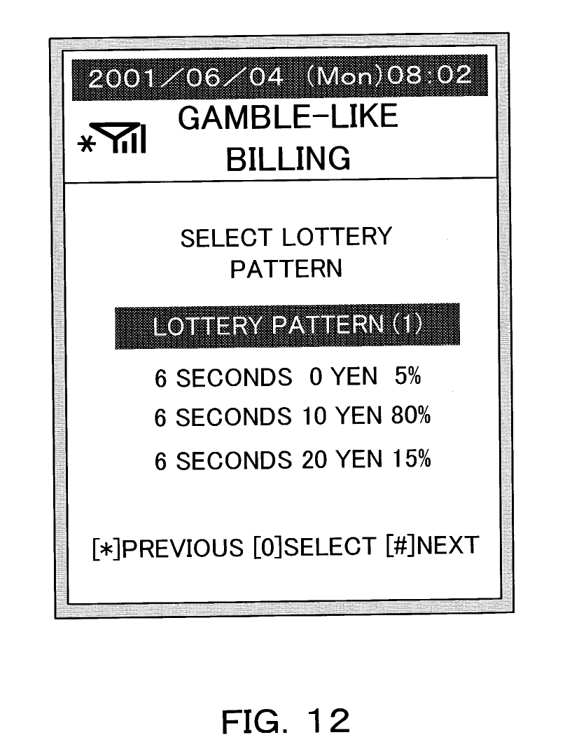

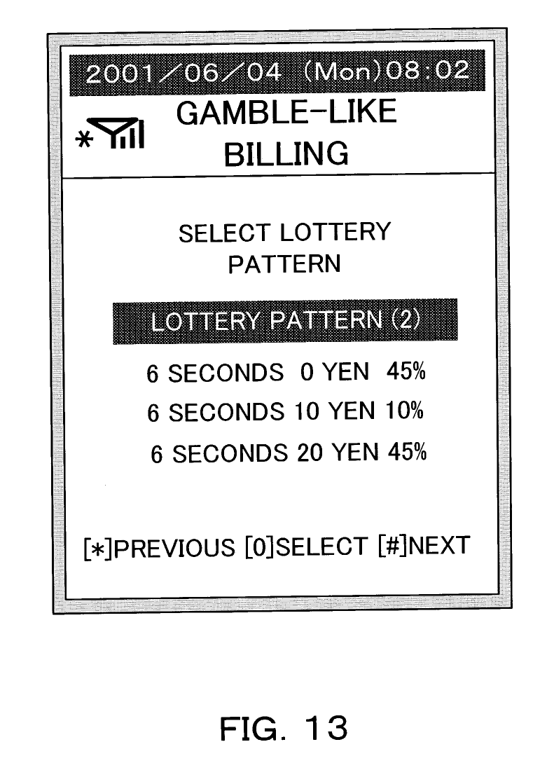

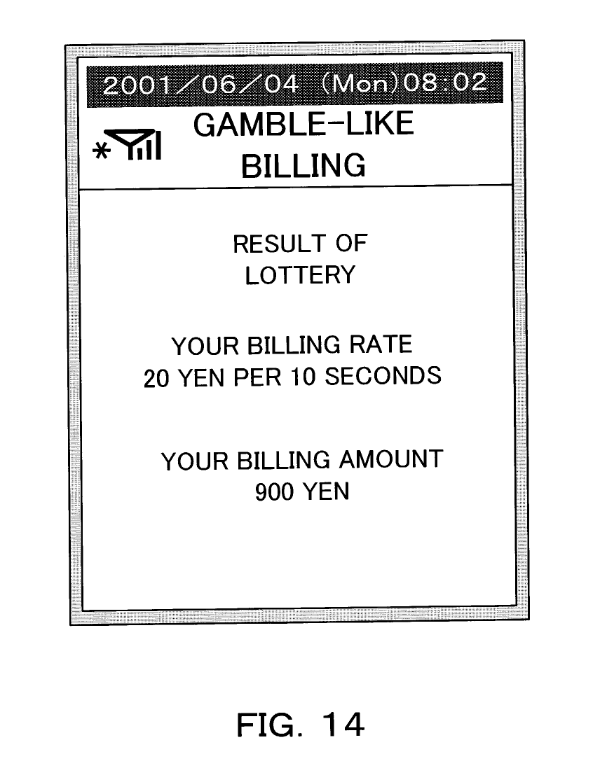

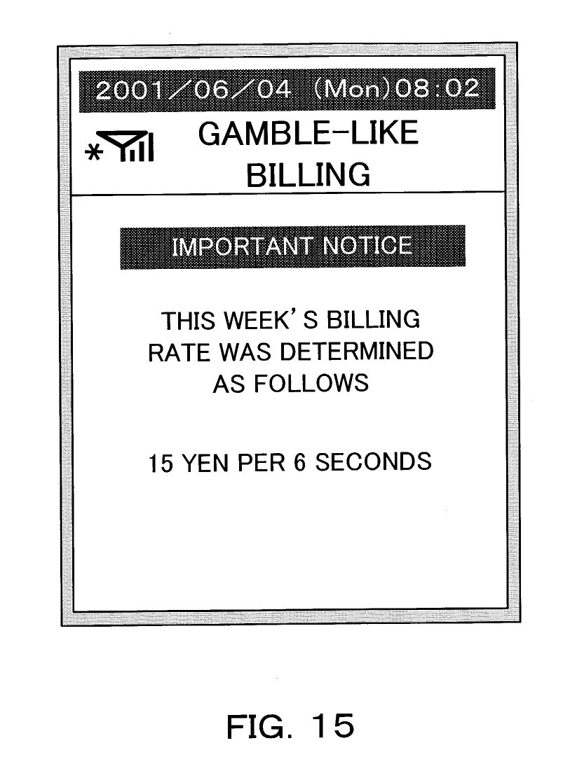

FIG. 11 shows a selection screen for use in selecting whether or not to use the probability lottery-type variable billing method of the invention. FIG. 12 shows a selection screen displaying a lottery pattern, and FIG. 13 shows a selection screen displaying another lottery pattern. FIG. 14 shows a notification screen displaying a determined billing amount, while FIG. 15 shows a notification screen reporting a billing rate determined for use over a predetermined time period.

First, after a call is cleared by the user, the FIG. 11 selection screen for use in selecting whether or not to use the probability lottery-type variable billing method of the invention is displayed [corresponding to Utilization Example 5]. When the user chooses not to use the method, internal processing is executed so as to cause a contracted billing rate of 10 yen every 6 seconds to be applied with 100% probability [corresponding to Utilization Example 4]. On the other hand, when the user determines to use the method, selection screens displaying respective lottery probability information items for selection are displayed as shown in FIGS. 12 and 13, and the user selects a desired lottery probability information item (lottery pattern) [corresponding to Utilization Example 6]. Then, a lottery of a billing rate is executed, and an actual billing amount is determined, followed by the results being reported to the user as shown in FIG. 14 [corresponding to Utilization Example 8].

Further, when the user wants an identical billing information item to be used over a predetermined time period [as described in “Utilization Example 2”], the user selects or determines a desired lottery probability information item (lottery pattern) from menu options as shown in FIGS. 12 and 13, or alternatively, the service provider selects a lottery probability information item and determines a billing rate to be used over the predetermined time period. Then, a notification of the determined billing rate as shown in FIG. 15 is sent to the user.

[Automated Teller Machine: Second Embodiment]

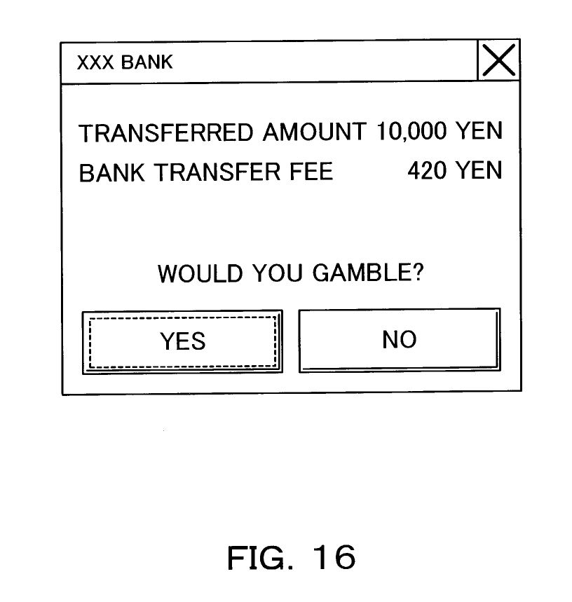

In this embodiment, the probability lottery-type variable billing method of the invention is applied to determination of a bank transfer fee, and a case of a normal bank transfer fee (in the case where the present invention is not utilized) of 420 yen being billed will be described with reference to FIGS. 16 to 20. Further, not a billing rate but a billing amount itself is stated in a billing information item.

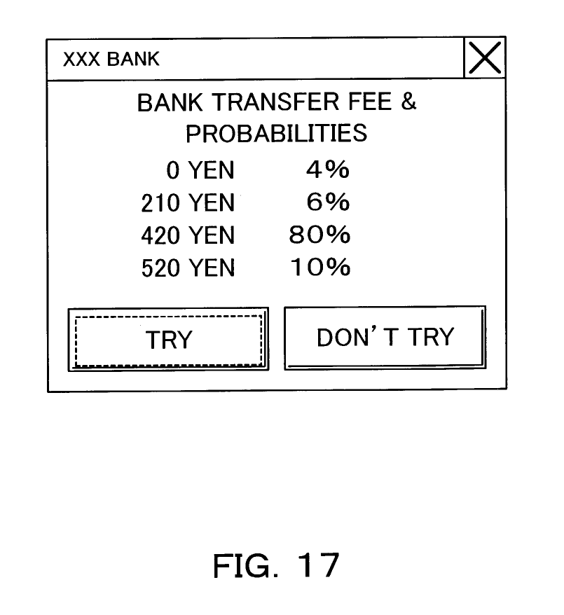

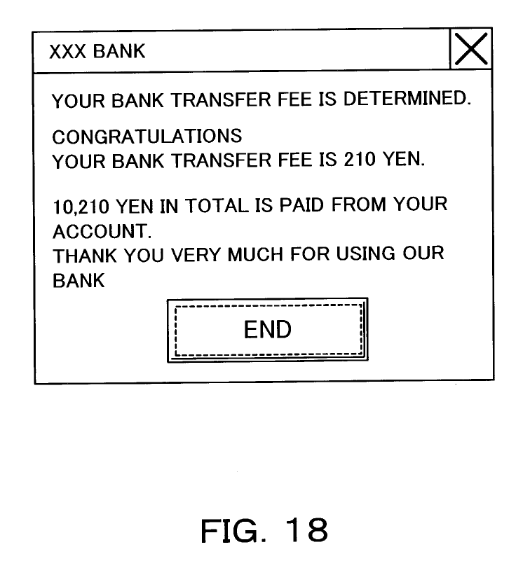

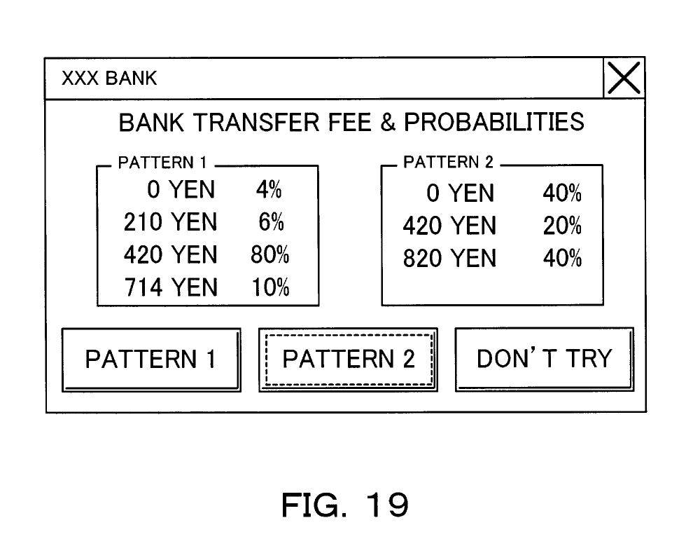

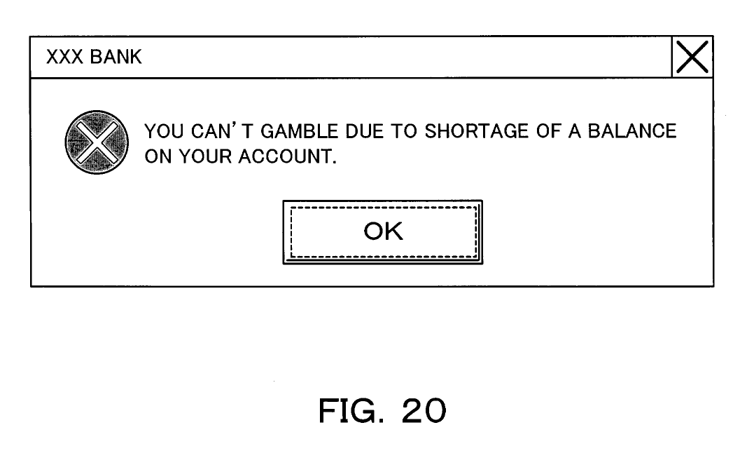

FIG. 16 illustrates a selection screen for use in selecting whether or not to use the probability lottery-type variable billing method of the invention. FIG. 17 illustrates a selection screen displaying a lottery probability information item for selection. FIG. 18 illustrates a notification screen reporting a determined fee, and FIG. 19 illustrates a selection screen for use in selecting lottery patterns. Further, FIG. 20 shows a warning screen warning a user of shortage of a balance on the user's account.

First, a normal fee is displayed on a screen of an automated teller machine, as shown in FIG. 16, and the user is urged to select whether or not to use the probability lottery-type variable billing method of the invention. When the user refuses to employ the method, the normal fee of 420 yen is billed. On the other hand, when the user uses the method and if there are a plurality of lottery probability information items for selection by the user, the information items are displayed on a selection screen (see FIG. 19), and then a selected lottery probability information item is displayed (see FIG. 17). Then, lottery processing is executed, and a determined billing amount is reported to the user (see FIG. 18). Needless to say, if a plurality of lottery probability information items are not provided, it is possible to omit the FIG. 19 screen.

In the automated teller machine, there are two methods of paying the fee. One method is using an ATM card to bill the fee to the user's account of the ATM card, and the other way is paying in cash. In the case of an ATM card being used, when the balance on the user's account is smaller than a maximum billing amount that may be determined by lottery, utilization of the probability lottery-type variable billing method of the invention must be denied (see FIG. 20). Otherwise, after determination of the fee, transaction will probably fail due to shortage of the balance on the user's account, which allows the user to retry the lottery. For the same reason, in the case of payment in cash, it is required to cause the user to deposit an amount of money which should be received from the user when the lottery determines the maximum bank transfer fee, before execution of the lottery, and when the bank transfer fee determined by lottery is smaller than the deposited amount, the difference has to be paid back.

[Internet Provider: Third Embodiment]

What an Internet provider is required to do whenever a service is utilized by a user is not to execute billing processing, but only to count time of service utilization by the user. Hence, billing processing is carried out collectively for all times of service utilization e.g. at the end of a month.

When the probability lottery-type variable billing method of the invention is applied to a usage-based billing system, a billing method identical to that described in the section [Telephone Exchange System] is employed in which a billing amount is calculated by multiplying service utilization time totalized so far by a billing rate determined by lottery. On the other hand, when the probability lottery-type variable billing method of the invention is applied to a fixed-rate billing system, similarly to the case described in the section [Automated Teller Machine], not a billing rate but a billing amount per se is recorded in each billing information item to calculate a billing amount. Further, when the usage-based billing method and the fixed-rate billing method are employed in combination, the probability lottery-type variable billing method of the invention can be applied to any one or both of the two methods.

[Packet Billing: Fourth Embodiment]

In the case of packet billing in which a billing amount is determined depending on the amount of data, it is only required to provide billing information per unit data amount in the billing system described in the section [Telephone Exchange System].

Although in the above embodiments, the probability lottery-type variable billing method of the invention is applied to the systems utilizing public facilities, this is not limitative, but the method is applicable to a game machine in a casino or a game house, or to a communication-type game machine or a home game machine.

As described above, according to the present invention, since a billing amount is varied according to a lottery probability, it is possible to provide a service user with a gambling feature in the determination of the billing amount, so that a service provider can easily attain differentiation from other companies. In particular, it is possible to create a new commercial value to gamblesome service users.

Further, probability distribution in a lottery probability information item can be changed, and billing information items can be increased or decreased in number or changed, so that it is possible to set numerous billing rates including a conventional fixed one on a user-by-user basis by using a single billing system.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A billing system in which a service provider bills for a provided service,
the billing system comprising:
a service-using terminal operated by a user of the service for requesting and receiving the service;
a communications relay station for providing said service-using terminal with the service in response to a request signal from said service-using terminal, and sending a notification that utilization of the service has started; and
a billing apparatus for storing in advance station data as billing data including at least one or more billing information items in which billing rates each defining a billing amount per unit time of utilization of the service are registered, respectively, and subscriber data as billing data specific to each subscriber, receiving the notification, presenting respective probabilities that the billing rates will be determined to said service-using terminal in advance, urging the user to make a selection and executing a lottery, determining a billing rate and storing the billing rate, calculating a billing amount based on the determined billing rate and saving the calculated billing amount, and notifying said service-using terminal of the calculated billing amount.

2. The billing system according to claim 1, wherein the lottery is executed after presenting a plurality of patterns of the lottery to be executed according to the presented probabilities that the billing rates will be determined, for selection by the user.

3. The billing system according to claim 1, wherein the station data further including:
at least one or more lottery probability information items in which specific ones of the billing information items and respective probabilities that the specific ones of the specific billing information items will be determined are associated with each other, and which are different from each other in relative proportion of the probabilities, and
a high-order lottery probability information item in which the at least one or more lottery probability information items and respective probabilities that the lottery probability information items will be determined by the lottery are associated with each other.

4. The billing system according to claim 1, wherein the subscriber data comprising:
applied lottery probability information that associates a plurality of applied billing information identifiers for identifying the billing information items, respectively, and respective probabilities that the identified billing information items will be determined, and
applied billing information that stores the billing rates determined by the lottery.

5. The billing system according to claim 1, wherein the billing amount is determined not only when a service request has been made by the user, but also by starting a predetermined process periodically.

6. The billing system according to claim 1, wherein the service provides a relay connection for communication to a destination designated by said service-using terminal.

7. A billing method by which a service provider bills for a provided service,
the billing method comprising the steps of:
requesting and receiving the service by a service-using terminal operated by a user of the service operating;
providing said service-using terminal with the service in response to a request signal from said service-using terminal, and sending a notification that utilization of the service has started to a billing apparatus for billing for the service, by a communications relay station; and
storing in advance station data as billing data including at least one or more billing information items in which billing rates each defining a billing amount per unit time of utilization of the service are registered, respectively, and subscriber data as billing data specific to each subscriber, receiving the notification, presenting respective probabilities that the billing rates will be determined to said service-using terminal in advance, urging the user to make a selection and executing a lottery, determining a billing rate and storing the billing rate, calculating a billing amount based on the determined billing rate and saving the calculated billing amount, and notifying said service-using terminal of the calculated billing amount, by the billing apparatus.

8. The billing method according to claim 7, wherein the lottery is executed after presenting a plurality of patterns of the lottery to be executed according to the presented probabilities that the billing rates will be determined, for selection by the user.

9. The billing method according to claim 7, wherein the station data further including:
at least one or more lottery probability information items in which specific ones of the billing information items and respective probabilities that the specific ones of the specific billing information items will be determined are associated with each other, and which are different from each other in relative proportion of the probabilities, and
a high-order lottery probability information item in which the at least one or more lottery probability information items and respective probabilities that the lottery probability information items will be determined by the lottery are associated with each other.

10. The billing method according to claim 7, wherein the subscriber data comprising:
applied lottery probability information that associates a plurality of applied billing information identifiers for identifying the billing information items, respectively, and respective probabilities that the identified billing information items will be determined, and
applied billing information that stores the billing rates determined by the lottery.

11. The billing method according to claim 7, wherein the billing amount is determined not only when a service request has been made by the user, but also by starting a predetermined process periodically.

12. The billing method according to claim 7, wherein the service provides a relay connection for communication to a destination designated by the service-using terminal.

13. A billing apparatus by which a service provider bills for a provided service,
the billing apparatus comprising:
a timer for starting a predetermined process periodically to give a notification of a timer event as a predetermined message;
a data section for storing in advance station data as billing data including at least one or more billing information items in which billing rates each defining a billing amount per unit time of utilization of the service are registered, respectively, and subscriber data as billing data specific to each subscriber,
a billing processing section including event reception processing means for receiving an event as a message notified by a device for relaying the service after the device has confirmed that connection to the service has been established, or receiving the timer event delivered from said timer after starting of the predetermined processing, internal billing data-generating means for generating the station data or the subscriber data each serving as the billing data, as internal billing data in a memory within the billing apparatus, probability-dependent billing processing means for presenting respective probabilities that the billing rates will be determined to a service-using terminal connected to the service in advance, urging the user to make a selection and executing a lottery, determining a billing rate and storing the billing rate, calculating a billing amount based on the determined billing rate and saving the calculated billing amount, and notifying the service-using terminal of the calculated billing amount, and internal billing data storage means for storing the internal billing data in said data section or in the device for relaying the service; and
a billing meter for storing the billing amount calculated by said billing processing section.

14. The billing apparatus according to claim 13, wherein the lottery is executed after presenting a plurality of patterns of the lottery to be executed according to the presented probabilities that the billing rates will be determined, for selection by the user.

15. The billing apparatus according to claim 13, wherein the station data further including:
at least one or more lottery probability information items in which specific ones of the billing information items and respective probabilities that the specific ones of the specific billing information items will be determined are associated with each other, and which are different from each other in relative proportion of the probabilities, and
a high-order lottery probability information item in which the at least one or more lottery probability information items and respective probabilities that the lottery probability information items will be determined by the lottery are associated with each other.

16. The billing apparatus according to claim 13, wherein the subscriber data comprising:
applied lottery probability information that associates a plurality of applied billing information identifiers for identifying the billing information items, respectively, and respective probabilities that the identified billing information items will be determined, and
applied billing information that stores the billing rates determined by the lottery.
